(19) United States
(12) Patent Application Publication
(10) Pub. No.: US 2003/0168280 A1
(43) Pub. Date: Sep. 11, 2003

(54) Vest for retaining a safety harness

(76) Inventor: Dennis K. Jones, Huntsville, AL (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/349,178

(22) Filed: Jan. 22, 2003

Related U.S. Application Data
(60) Provisional application No. 60/350,577, filed on Jan. 22, 2002.

(51) Int. Cl. A62B 35/00

(52) U.S. Cl. 182/3

(57) ABSTRACT

A vest for retaining and organizing a safety harness. Straps of the harness are secured in harness connectors of the vest to prevent tangling of the harness and to make it easier and faster for a wearer to don the harness.

### CROSS-REFERENCE TO RELATED APPLICATION

This application claims the benefit of U.S. Provisional Patent Application Serial No. 60/350,577, filed Jan. 22, 2002, the entirety of which is hereby incorporated herein by reference for all purposes.

### BACKGROUND OF THE INVENTION

1. Field of the Invention

The present invention relates generally to the field of safety equipment, and more particularly to a device and method for organizing and retaining a safety harness in a ready-to-wear configuration.

2. Description of Related Art

Safety harnesses are used to prevent or reduce injuries resulting from falls, and to secure personnel and equipment in elevated or difficult to access positions. For example, construction workers and hunters often engage in their respective activities on raised scaffolds, tree-stands, or other elevated structures. A safety harness may be worn about the wearer's torso, and a safety line or tether secured to the harness and to a support, in order to prevent falls or to limit the distance fallen in the event a fall does occur.

Many previously known safety harness devices have been found to be prone to tangling during use, storage, donning and/or removal. In particular, if a typical harness is removed and stowed for even a short time, the harness straps may become entangled with one another, requiring considerable time and effort to untangle for re-use. At best, such difficulties reduce efficiency and increase user annoyance. At worst, such difficulties may discourage the use of a safety harness, possibly leading to injury or death from a fall.

Thus, it has been found that needs exist for improved safety equipment and methods for retaining a safety harness in a ready-to-use configuration, and preventing tangling of a safety harness. It is to the provision of improved safety equipment and methods meeting these and other needs that the present invention is primarily directed.

### SUMMARY OF THE INVENTION

In an example embodiment, the present invention is a vest for preventing a safety harness from becoming a tangled mess, and for retaining a safety harness in a ready-to-use configuration during storage, transport, use and/or removal of the harness. This is particularly advantageous for hunters, construction workers, and the like, who often must put a safety harness on in the dark and/or in cold weather wearing gloves. The vest of the present invention is preferably a universal-fit piece of equipment, accommodating many or most types and brands of safety harnesses on the market. In example embodiments, the vest of the present invention is configured as a garment to be worn about the torso of a human being, and is available in different sizes for different sizes of wearers. As used herein, the term “vest” is intended to include garments with or without sleeves.

Example forms of the vest are preferably designed with webbing straps or material enclosures such as button-snaps, hook-and-loop attachments, buttons, or the like at key locations on the inside. The straps or material enclosures preferably secure the safety harness to the inside of the vest in the specified wearing configuration applicable to the particular type of harness. In alternate embodiments, the harness is secured to the outside of the vest. The vest preferably includes one or more pockets on the inside of the front panels. The pockets are optionally formed from the material enclosures. A slit is preferably provided down the back of the vest to accommodate different tether placements on different types of harnesses.

In one embodiment, the present invention is a vest for use in keeping a safety harness detangled. The vest preferably includes a rear panel having a plurality harness connectors spaced throughout the rear panel and having first and second sides. A first front panel is preferably connected adjacent a portion of the first side of the rear panel, the connection creating a first arm receptacle such as an arm-hole or sleeve, and the first front panel comprising a plurality of harness connectors. A second front panel is preferably connected adjacent a portion of the second side of the rear panel, the connection creating a second arm receptacle such as an arm-hole or sleeve, and the second panel comprising a plurality of harness connectors. Inserting the harness into the connectors preferably de-tangles the harness and facilitates easy use of the harness by a user that inserts his or her arms into the arm receptacles.

In another embodiment, the present invention is a vest for retaining a safety harness and preventing tangling of the harness. The vest preferably includes a garment to be worn about the torso of a wearer; and at least one pair of harness connectors for securing portions of the harness to the garment.

Another embodiment of the present invention is a vest for retaining a safety harness and preventing tangling of the harness. The vest preferably includes a garment to be worn about the torso of a wearer, the garment having a rear panel, first and second front panels, and at least one fastener for engaging the first front panel to the second front panel. The vest preferably also includes at least one pair of harness connectors arranged on the first and second front panels of the garment, and at least two pairs of harness connectors arranged on the rear panel of the garment. The vest preferably also includes at least one slit formed in a back portion of the garment for receiving a tether portion of the harness.

In still another embodiment, the present invention is a safety harness in combination with a vest. The combination preferably includes a harness having at least one portion for securing about a wearer, and a tether for connection to an external support. The combination preferably also includes a garment to be worn about the torso of a wearer, the garment having at least one pair of harness connectors for releasably engaging the harness, and at least one opening for passing the tether of the harness therethrough.

These and other features and advantages of preferred forms of the present invention are described herein with reference to the drawing figures.

### BRIEF DESCRIPTION OF THE DRAWING FIGURES

FIG. 1 shows an inside view of a vest according to one embodiment of the present invention.

FIG. 2 shows an outside view of a vest according to one embodiment of the present invention.

### DETAILED DESCRIPTION

Referring now to the drawing figures, in which like reference numbers refer to like parts throughout, preferred forms of the present invention will now be described by way of example embodiments. It is to be understood that the embodiments described and depicted herein are only selected examples of the many and various forms that the present invention may take, and that these examples are not intended to be exhaustive or limiting of the claimed invention. Also, as used in the specification including the appended claims, the singular forms “a,” “an,” and “the” include the plural unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

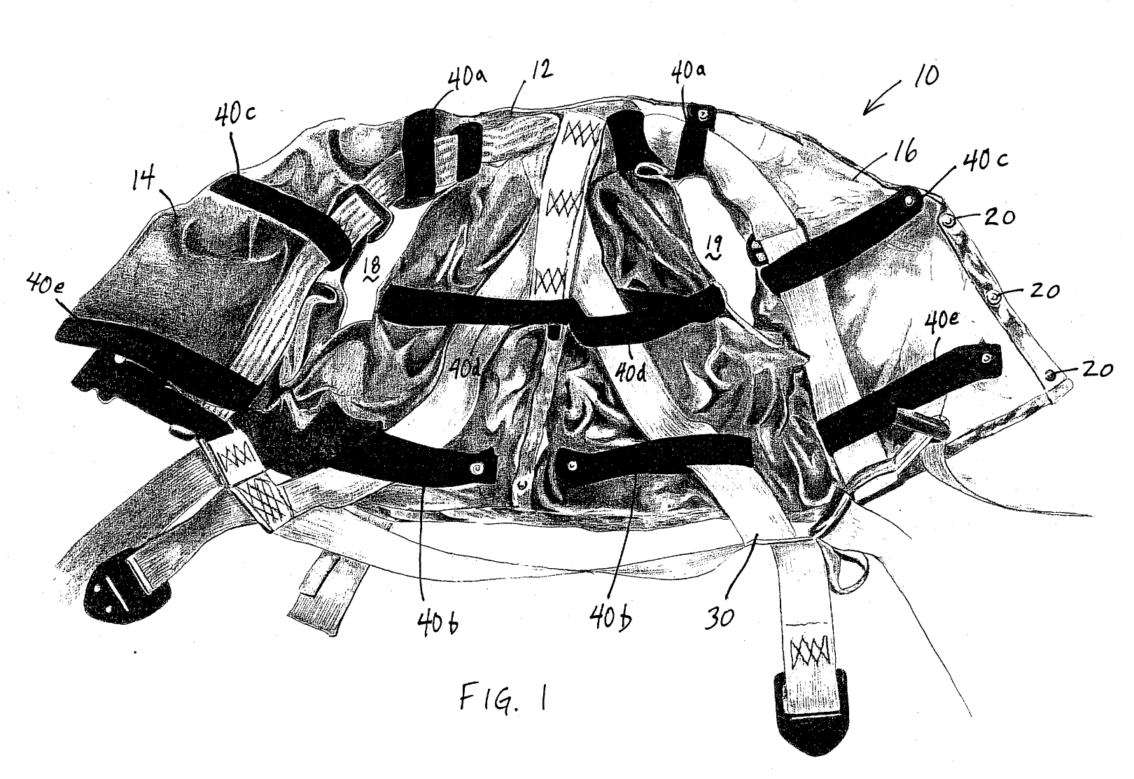

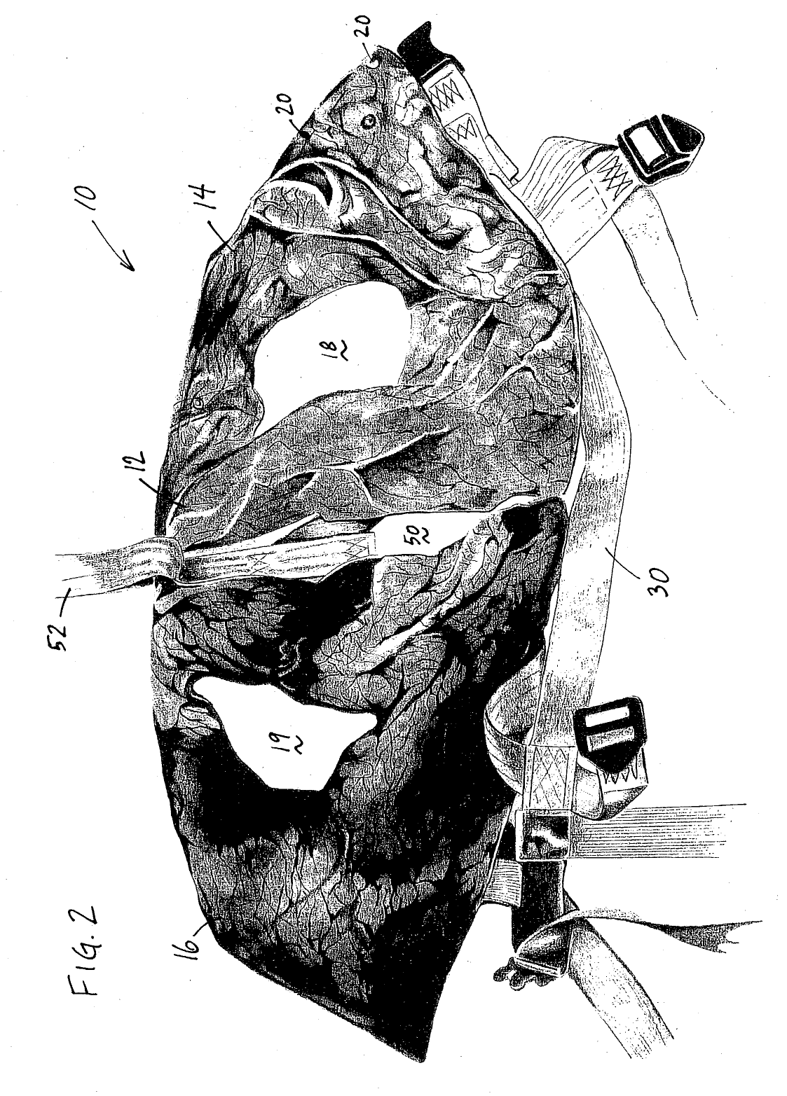

With particular reference now to FIGS. 1 and 2, the present invention will be described by way of an example embodiment. A vest 10 generally comprises a garment sized and shaped to be worn about the torso of a human wearer. The vest 10 preferably comprises a back or rear panel 12 configured to overlie the upper and/or lower back of the wearer in use, a first front panel 14 adapted to overlie at least a first portion of the chest and/or abdominal area of the wearer in use, and a second front panel 16 adapted to overlie at least a second portion of the chest and/or abdominal area of the wearer in use. The rear panel 12 and the first and second front panels 14, 16 are preferably fabricated from one or more flexible materials such as a natural or synthetic fabric or sheeting. The panels 12, 14, 16 are preferably separate pieces joined by stitching, adhesive, welding or bonding, or other attachment means; or alternatively are integrally formed as a single piece. A first arm receptacle 18 such as an arm-hole or sleeve is preferably positioned between the first front panel 14 and the rear panel 12, and a second arm receptacle 19 such as an arm-hole or sleeve is preferably positioned between the second front panel 16 and the rear panel 12.

The panels 12, 14, 16 optionally may be provided with external and/or internal markings or colorings, such as for example: camouflage, blaze orange or other high-visibility colors, military or police identification, instructions for use, wearer identification, size designation, etc. In a further optional embodiment, the vest 10 is reversible, for example having camouflage on one face of the panels and blaze orange on the other face of the panels. One or more pockets are optionally provided on the interior and/or exterior faces of the vest 10.

The first and second front panels 14, 16 preferably incorporate one or more pairs of cooperating fasteners 20, such as snaps, buttons, hook-and-loop fasteners, or the like for engaging portions of the first and second panels together to secure the vest 10 on the wearer in use. In an alternate embodiment, the fasteners 20 are double-sided, fastenable on either face of the vest 10, allowing reversible wearing. Optionally, the vest 10 further comprises long or short sleeves to cover all or portions of the arms of the wearer in use, a collar for surrounding the wearer's neck, a hood for covering a portion of the wearer's head, a tail extension for covering the lower back and buttocks of the wearer and/or for serving as a seat, and/or other garment components. Optionally, the vest 10 further includes a seat portion, one or more pockets, and/or other components for releasable attachment to one or more of the panels 12, 14, 16, as by snaps, buttons, hook-and-loop fastener, or the like. In further alternate embodiments, the first and second front panels 14, 16 are a single component or are permanently joined, and the vest 10 is generally configured as a “pull-over” garment.

The vest 10 preferably comprises one or more harness connectors 40 for securing a safety harness 30. For example, in the depicted embodiment, at least three pairs of harness connectors 40 are provided: a pair of upper-back harness connectors 40a; a pair of lower back harness connectors 40b, and a pair of front harness connectors 40c. Optionally, additional pairs of harness connectors, such as mid-back connectors 40d, and lower-front connectors 40e are also provided. The harness connectors 40 are preferably positioned to engage corresponding straps or portions of a safety harness 30, and the positions designated herein have been found to be of generally universal application for engagement of straps or portions of a wide variety of commercially available standard harness types and brands. The harness connectors 40 are preferably fabricated of a flexible material such as nylon webbing, natural or synthetic fabric or strapping, leather, or the like. The harness connectors 40 are preferably secured to the vest 10 in the desired location(s) by stitching, adhesive, welding or bonding, or other permanent attachment means. Alternatively, the harness connectors 40 are integrally formed with the vest 10, or are secured to the vest 10 by releasable attachment means such as snaps, buttons, hook-and-loop fasteners, or the like. The provision of releasable attachment means advantageously permits selective re-positioning of the harness connectors on the vest, allowing the user to customize the vest to a particular harness type or to the user's preferences. The harness connectors 40 preferably each comprise means for securing a strap or other portion of the harness 30, such as a loop, hook, pin or clip for receiving or retaining the harness portion. In embodiments comprising a loop for receiving the harness strap, the loop preferably is formed by attaching a free end of the harness connector 40 to the vest 10 and/or to a fixed portion of the harness connector as by a snap, button, hook-and-loop fastener or other releasable connection means. In alternate embodiments, the loop comprises a material enclosure or other permanently attached loop or opening, through which the strap or other harness portion is threaded. In another embodiment, the loop or opening is formed through or under a pocket formed in or attached to the vest 10.

The vest 10 preferably includes at least one slit or other opening 50 in the rear panel 12, preferably overlying the dorsal region of the wearer's back when worn. The opening is preferably sized and positioned to permit passage of a tether strap 52 portion of the harness 30 therethrough, for connection to an external support. The opening 50 optionally includes one or more closure elements for selectively opening and closing all or portions of the opening; and/or multiple openings are provided through the vest 10 in different locations, for accomodating the tether location of different types or brands of harnesses.

An example method of use of the vest 10 of the present invention preferably comprises the wearer putting on a harness 30 and adjusting the shoulder straps to fit. The vest is then pulled on over the harness. The tether strap 52 of the harness 30 is pulled through the slit 20 at the back of the vest 10. If more than one slit location is provided, the tether is adjusted by placement through the uppermost slit location capable of comfortably accommodating the tether. The webbing straps or material enclosures of the harness connectors 40c are snapped at the front of the vest around the front shoulder straps of the harness. The vest is removed and laid on a flat surface. The harness connectors 40a and 40b are secured to the shoulder straps at the back of the harness 30. The harness and vest are lifted by grasping the tether of the harness and putting the vest and attached harness onto the wearer in the manner of a typical garment. The fasteners 20, if provided, are fastened to secure the vest 10 about the wearer's torso.

While the invention has been described in its preferred forms, it will be readily apparent to those of ordinary skill in the art that many additions, modifications and deletions can be made thereto without departing from the spirit and scope of the invention.

What is claimed is:

1. A vest for retaining a safety harness and preventing tangling of the harness, said vest comprising:
a garment to be worn about the torso of a wearer; and
at least one pair of harness connectors for securing portions of the harness to the garment.

2. The vest of claim 1, wherein the garment comprises a rear panel and first and second front panels, and further comprising at least one pair of harness connectors arranged on the first and second front panels, and at least two pairs of harness connectors arranged on the rear panel.

3. The vest of claim 2, comprising upper and lower pairs of harness connectors arranged on the first and second front panels.

4. The vest of claim 1, further comprising at least one slit formed in a back portion of the garment for receiving a tether portion of the harness.

5. The vest of claim 1, wherein the at least one pair of harness connectors comprise straps secured to the garment, said straps comprising a free end and releasable connection means for securing a portion of the harness within a loop formed by the harness connectors.

6. The vest of claim 1, wherein the at least one pair of harness connectors comprise material enclosures for receiving a portion of the harness therethrough.

7. The vest of claim 1, wherein said garment comprises a rear panel, first and second front panels, and at least one fastener for engaging the first front panel to the second front panel.

8. The vest of claim 1, wherein said garment comprises a rear panel, first and second front panels, and arm-holes between the rear panel and the first front panel and between the rear panel and the second front panel.

9. The vest of claim 8, further comprising sleeves extending from said arm-holes.

10. The vest of claim 1, wherein said garment is reversible, comprising a first face having a first color/pattern and a second face having a second color/pattern.

11. The vest of claim 1, wherein said at least one pair of harness connectors are releasably secured to said garment for selective re-positioning.

12. A vest for retaining a safety harness and preventing tangling of the harness, said vest comprising:
a garment to be worn about the torso of a wearer, said garment comprising a rear panel, first and second front panels, and at least one fastener for engaging the first front panel to the second front panel;
at least one pair of harness connectors arranged on the first and second front panels of the garment, and at least two pairs of harness connectors arranged on the rear panel of the garment; and
at least one slit formed in a back portion of the garment for receiving a tether portion of the harness.

13. The vest of claim 12, comprising upper and lower pairs of harness connectors arranged on the first and second front panels.

14. The vest of claim 12, wherein said harness connectors comprise straps secured to the garment, said straps comprising a free end and releasable connection means for securing a portion of the harness within a loop formed by the harness connectors.

15. The vest of claim 12, wherein said harness connectors comprise material enclosures for receiving a portion of the harness therethrough.

16. The vest of claim 12, wherein said garment comprises arm-holes between the rear panel and the first front panel and between the rear panel and the second front panel, and further comprises sleeves extending from said arm-holes.

17. The vest of claim 12, wherein said garment is reversible, comprising a first face having a first color/pattern and a second face having a second color/pattern.

18. The vest of claim 12, wherein said at least one pair of harness connectors are releasably secured to said garment for selective re-positioning.

19. A safety harness in combination with a vest, said combination comprising:
a harness comprising at least one portion for securing about a wearer, and a tether for connection to an external support; and
a garment to be worn about the torso of a wearer, the garment comprising at least one pair of harness connectors for releasably engaging the harness, and at least one opening for passing the tether of the harness therethrough.
